(19) United States
(12) Patent Application Publication
(10) Pub. No.: US 2018/0357584 A1
(43) Pub. Date: Dec. 13, 2018

(54) METHOD AND SYSTEM FOR COLLABORATIVE SCHEDULING OF PRODUCTION AND TRANSPORTATION IN SUPPLY CHAINS BASED ON IMPROVED PARTICLE SWARM OPTIMIZATION

(71) Applicant: Hefei University of Technology, Hefei (CN)

(72) Inventors: Xinbao LIU, Hefei (CN); Jun PEI, Hefei (CN); Mei XUE, Hefei (CN); Shaojun LU, Hefei (CN); Hao CHENG, Hefei (CN); Min KONG, Hefei (CN); Zhiping ZHOU, Hefei (CN); Lu JIANG, Hefei (CN)

(21) Appl. No.: 16/006,769

(22) Filed: Jun. 12, 2018

(30) Foreign Application Priority Data
Jun. 12, 2017 (CN) 201710439821.9

(51) Int. Cl. G06Q 10/06; G06Q 10/08

(52) U.S. Cl. CPC G06Q 10/06311; G06Q 10/083

(57) ABSTRACT

The present invention discloses a method and system for collaborative scheduling of production and transportation in supply chains based on improved particle swarm optimization. The method includes the following steps: 1. setting algorithm parameters; 2. randomly generating an initial population; 3. correcting codes; 4. calculating fitness values and updating the speed and the position of particles; 5. performing tournament selection; 6. performing crossover mutation; 7. updating the population; and 8. determining whether a termination condition is satisfied; if so, outputting a globally optimal solution; if not, returning to the step 3. In the present invention, an approximately optimal solution can be obtained in view of the collaborative scheduling problem of production and transportation considering distributed storage, so that the cost is reduced for supply chains and the service level of supply chains is enhanced.

### TECHNICAL FIELD

The present invention relates to the technical field of supply chains, and in particular to a method and system for collaborative scheduling of production and transportation in supply chains based on improved particle swarm optimization.

### BACKGROUND OF THE PRESENT INVENTION

In recent years, the collaborative scheduling problem of production and transportation has become one of hot topics in studies on supply chain scheduling. In 2003, Hall, et al. explained the concept of supply chain scheduling for the first time, and proposed a dynamic programming algorithm in view of the problem of supply chain scheduling between a single plant and multiple clients to optimize the time and the cost for delivery. Then, studies on the scheduling problem go more and more in-depth. Here, the improved particle swarm optimization constructed for maximizing the benefits of supply chains is based on the existing particle swarm optimization (Kennedy and Eberhart, 1995). By introducing crossover operators and mutation operators, the situation that particles plunge into premature convergence too early is improved and the diversity of particles is increased. Therefore, the rational arrangement of job sequencing, job batching and transportation delivery schemes is realized. The particle swarm optimization generally includes the following steps: (1) initializing the position and the speed of particles; (2) calculating fitness values, and recording an optimal solution and a globally optimal solution in the current generation; (3) updating the speed and the position of particles; and, (4) updating the optimal solution and the globally optimal solution in the current generation. By repeating the above steps, an optimal solution is searched from the whole space.

However, there are relatively few studies on the collaborative scheduling problem of production and transportation of semi-finished products at present. Scheduling models proposed by many scholars mostly focus on machine environments, production features and resource optimization, but ignore the transportation of semi-finished products and the influence of finished product assignment on production. Meanwhile, considering the collaboration of machine scheduling with product transportation is of great important to increase the productivity of enterprises, because the cost is greatly reduced for supply chains, and the competitiveness of supply chains is increased. In addition, in terms of the used method, the particle swarm optimization has the disadvantages of poor global convergence, premature convergence and the like. Particularly, for some particular optimization problems, stable and reliable solutions cannot be provided, so that it is disadvantageous for the improvement of the collaborative efficiency in supply chains. Therefore, it is necessary to accordingly improve the particle swarm optimization according to the specific project to realize collaborative optimization of supply chains.

### SUMMARY OF THE PRESENT INVENTION

An objective of embodiments of the present invention is to improve the rationality of a scheduling process of jobs on batch processors.

In a first aspect, the embodiments of the present invention provide a method for collaborative scheduling of production and transportation in supply chains based on improved particle swarm optimization, including:

step 1: obtaining the number of jobs transported by each warehouse; obtaining a sequence of jobs on a first-come-first-served basis; representing a code of the m^{th} particle by a vector Xₘ={x₁ₘ, x₂ₘ, . . . , xᵢₘ, . . . , xₙₘ}, elements of which are valued as 0 or 1; and when an element is valued as 1, putting elements valued as 0 in front of the element into a batch, where all vectors in the n^{th} dimension are valued as 1;

step 2: initializing a particle swarm, determining a population size M of the particle swarm, the dimension D of particles, the number of iterations t=0, the maximum number of iterations tₘₐₓ, and the position xᵢₘ and the speed vᵢₘ of particles, and assigning 0 or 1 to each dimension of each particle according to an encoding rule; and selecting a random number rand between 0 and 1 and calculating the position and the speed of particles in the following way:

vᵢₘ^{t+1}=w*vᵢₘ^{t}+c₁*r₁*(pbᵢ^{t}−xᵢₘ^{t})+c₂*r₂*(gbᵢ^{t}−xᵢₘ^{t})

where, w, c₁, c₂ are constant coefficients;

$$Sig ( {v}_{im} ) = \frac{1}{1 + exp ( - {v}_{im} )}$$

$${x}_{im} = \{ \begin{matrix}1 , & Sig ( {v}_{im} ) \geq rand \\ 0 , & Sig ( {v}_{im} ) < rand\end{matrix} ;$$

step 3: correcting an initial solution according to a BU rule, assigning batches to corresponding machines for processing according to an MF batch assignment rule, calculating a fitness value for each particle by a fitness function, and updating an optimal position pb of individuals and a globally optimal position gb;

step 4: selecting particles by a “tournament” method, sequencing the particles in non-decreasing order of the fitness values, and selecting first 20% particles to perform a randomly pairwise crossover operation on the premise of ensuring the number of particles to be an even number, rounding off the number of particles if it is a decimal and adding 1 to the number of particles if it is an odd number, to generate corresponding filial particles to replace parent particles;

step 5: correcting the initial solution according to the BU rule, assigning batches to corresponding machines for processing according to the MF batch assignment rule, calculating a fitness value for each particle by the fitness function, and updating the optimal position pb of individuals and the globally optimal position gb;

step 6: calculating the mutation probability of particles to perform mutation, calculating fitness values for particles according to the BU rule and the MF batch assignment rule, and updating the optimal position pb of individuals and the globally optimal position gb;

step 7: calculating the speed and the position of all particles, updating the position xᵢₘ of particles, calculating a fitness value for each particle, and updating the optimal position pb of individuals and the globally optimal position gb, where t=t+1;

step 8: determining whether t≤tₘₐₓ is satisfied; if so, returning to the step 3; if not, ending the algorithm, and outputting the globally optimal solution gb as well as the optimal batching mode and batch processing sequences on each machine.

Optionally, the step of correcting an initial solution according to a BU rule includes:

step 1′: setting i=1 and j=1 for a given individual Xₘ;

step 2′: assigning a job i to the j^{th} batch if xᵢₘ=0, where i=i+1; or otherwise, assuming j=j+1, and assigning the job i to the j^{th} batch;

step 3′: determining whether i>1 is satisfied; if so, returning to the step 2′; if not, obtaining all sets of batches;

step 4′: for any batch Bⱼ, if the capacity of Bⱼ is greater than B, then: selecting a job J* arriving at a machine at the latest during transportation from a warehouse to a manufacturer and placing the job J* in a batch Bⱼ₊₁ if |Bⱼ|−B+|Bⱼ₊₁|≤B, where |Bⱼ| represents the number of jobs contained in the batch Bⱼ; or otherwise, inserting a new batch in the position j+1, placing the job J* in the batch Bⱼ₊₁, and removing the job J* from the batch Bⱼ;

step 5′: repeating the step 4′ until all batches satisfy the requirement on the capacity.

Optionally, the step of assigning batches to corresponding machines for processing according to an MF batch assignment rule includes:

step 1″: obtaining the processing time P_{b} for each batch bₖ and setting a parameter NE after batching jobs according to batch correction;

step 2″: determining upper and lower bounds for batch assignment according to the following laws:

for the lower bound:

if

$$max ( {P}_{b} , b ∈ B ) \geq \frac{{\sum }_{b ∈ B} {P}_{b}}{\vert M \vert}$$

is satisfied, assuming LB=max(P_{b},b∈B); or otherwise, assuming

$$LB = \frac{{\sum }_{b ∈ B} {P}_{b}}{\vert M \vert} ;$$

for the upper bound:

if

$$max ( {P}_{b} , b ∈ B ) \geq \frac{2 {\sum }_{b ∈ B} {P}_{b}}{\vert M \vert}$$

is satisfied, assuming UB=max(P_{b},b∈B); or otherwise, assuming

$$UB = \frac{2 {\sum }_{b ∈ B} {P}_{b}}{\vert M \vert} ,$$

where |M| is the total number of machines and max(P_{b}, b∈B) represents the maximum batch processing time in all batches;

step 3″: assuming

$${C}_{max} = \frac{LB + UB}{2} ;$$

step 4″: selecting one batch for assignment to a machine every time and ensuring the sum of processing time for this machine not exceeding Cₘₐₓ;
if the batch cannot be put on the machine under the limitation of not exceeding Cₘₐₓ, resetting LB=Cₘₐₓ; or otherwise, resetting UB=Cₘₐₓ;

step 5″: determining whether

$$\frac{UB - LB}{LB} \leq NE$$

is satisfied; if so, ending the circulation; if not, returning to the step 3″.

Optionally, the step of selecting particles by a “tournament” method, sequencing the particles in non-decreasing order of the fitness values, and selecting first 20% particles to perform a randomly pairwise crossover operation includes:

step 41: randomly selecting two individuals, comparing fitness values for the two individuals, and selecting the individual with a larger fitness value as the candidate crossover particle; selecting 20% particles from a population to perform a randomly pairwise crossover operation on the selected particles on the premise of ensuring the number of particles to be an even number, rounding off the number of particles if it is a decimal and adding 1 to the number of particles if it is an odd number, to generate corresponding filial particles to replace parent particles, wherein the specific crossover method is as follows: on the basis of dimensions, randomly generating 0 or 1 for each dimension; if it is 1, exchanging the value of the dimension; or otherwise, not exchanging the value;

step 42: calculating the mutation probability of a particle m according to the following formula:

$${P}_{m} = \{ \begin{matrix}{P}_{1} - \frac{( {P}_{1} - {P}_{2} ) ( {f}_{avg} - f )}{{f}_{avg} - {f}_{min}} , & f \leq {f}_{avg} \\ {P}_{1} , & f > {f}_{avg}\end{matrix}$$

where, fₘᵢₙ represents a fitness value for the globally optimal position, f_{avg} represents an average fitness value, f represents a fitness value for the current particle, P₁=0.1 and P₂=0.01; generating a random decimal within [0,1] for each particle and comparing the random decimal with Pₘ; if it is less than Pₘ, performing mutation on the particle, or otherwise, not performing mutation, where the specific mutation method is as follows: on the basis of dimensions, randomly generating 0 or 1 for each dimension; if it is 1, performing mutation on the value of the dimension to change 1 to 0 or change 0 to 1, or otherwise, not performing mutation.

In a second aspect, the embodiments of the present invention provide a system for collaborative scheduling of production and transportation in supply chains based on improved particle swarm optimization, including:

a calculation module used for:

step 1: obtaining the number of jobs transported by each warehouse; obtaining a sequence of jobs on a first-come-first-served basis; representing a code of the m^{th} particle by a vector Xₘ={x₁ₘ, x₂ₘ, . . . , xᵢₘ, . . . , xₙₘ}, elements of which are valued as 0 or 1; and when an element is valued as 1, putting elements valued as 0 in front of the element into a batch, where all vectors in the n^{th} dimension are valued as 1;

step 2: initializing a particle swarm, determining a population size M of the particle swarm, the dimension D of particles, the number of iterations t=0, the maximum number of iterations tₘₐₓ, and the position xᵢₘ and the speed vᵢₘ of particles, and assigning 0 or 1 to each dimension of each particle according to an encoding rule; and selecting a random number rand between 0 and 1 and calculating the position and the speed of particles in the following way:

vᵢₘ^{t+1}=w*vᵢₘ^{t}+c₁*r₁*(pbᵢ^{t}−xᵢₘ^{t})+c₂*r₂*(gbᵢ^{t}−xᵢₘ^{t})

where, w, c₁, c₂ are constant coefficients;

$$Sig ( {v}_{im} ) = \frac{1}{1 + exp ( - {v}_{im} )}$$

$${x}_{im} = \{ \begin{matrix}1 , Sig ( {v}_{im} ) \geq rand \\ 0 , Sig ( {v}_{im} ) < rand\end{matrix} ;$$

step 3: correcting an initial solution according to a BU rule, assigning batches to corresponding machines for processing according to an MF batch assignment rule, calculating a fitness value for each particle by a fitness function, and updating an optimal position pb of individuals and a globally optimal position gb;

step 4: selecting particles by a “tournament” method, sequencing the particles in non-decreasing order of the fitness values, and selecting first 20% particles to perform a randomly pairwise crossover operation on the premise of ensuring the number of particles to be an even number, rounding off the number of particles if it is a decimal and adding 1 to the number of particles if it is an odd number, to generate corresponding filial particles to replace parent particles;

step 5: correcting the initial solution according to the BU rule, assigning batches to corresponding machines for processing according to the MF batch assignment rule, calculating a fitness value for each particle by the fitness function, and updating the optimal position pb of individuals and the globally optimal position gb;

step 6: calculating the mutation probability of particles to perform mutation, calculating fitness values for particles according to the BU rule and the MF batch assignment rule, and updating the optimal position pb of individuals and the globally optimal position gb;

step 7: calculating the speed and the position of all particles, updating the position xᵢₘ of particles, calculating a fitness value for each particle, and updating the optimal position pb of individuals and the globally optimal position gb, where t=t+1;

step 8: determining whether t≤tₘₐₓ is satisfied; if so, returning to the step 3; if not, ending the algorithm, and outputting the globally optimal solution gb;

an output module used for outputting the optimal batching mode and batch processing sequences on each machine.

Optionally, the step of correcting an initial solution according to a BU rule by the calculation module includes:

step 1′: setting i=1 and j=1 for a given individual Xₘ;

step 2′: assigning a job i to the j^{th} batch if xᵢₘ=0, where i=i+1; or otherwise, assuming j+1, and assigning the job i to the j^{th} batch;

step 3′: determining whether i>1 is satisfied; if so, returning to the step 2′; if not, obtaining all sets of batches;

step 4′: for any batch Bⱼ, if the capacity of Bⱼ is greater than B, then: selecting a job J* arriving at a machine at the latest during transportation from a warehouse to a manufacturer and placing the job J* in a batch Bⱼ₊₁ if |Bⱼ|−B+|Bⱼ₊₁|≤B, where |Bⱼ| represents the number of jobs contained in the batch Bⱼ; or otherwise, inserting a new batch in the position j+1, placing the job J* in the batch Bⱼ₊₁, and removing the job J* from the batch Bⱼ;

step 5′: repeating the step 4′ until all batches satisfy the requirement on the capacity.

Optionally, the step of assigning batches to corresponding machines for processing according to an MF batch assignment rule by the calculation module includes:

step 1″: obtaining the processing time P_{b} for each batch bₖ and setting a parameter NE after batching jobs according to batch correction;

step 2″: determining upper and lower bounds for batch assignment according to the following laws:

for the lower bound:

if

$$max ( {P}_{b} , b ∈ B ) \geq \frac{{\sum }_{b ∈ B} {P}_{b}}{\vert M \vert}$$

is satisfied, assuming LB=max(P_{b},b∈B); or otherwise, assuming

$$LB = \frac{{\sum }_{b ∈ B} {P}_{b}}{\vert M \vert} ;$$

for the upper bound:

if

$$max ( {P}_{b} , b ∈ B ) \geq \frac{2 {\sum }_{b ∈ B} {P}_{b}}{\vert M \vert}$$

is satisfied, assuming UB=max(P_{b},b∈B); or otherwise, assuming

$$UB = \frac{2 {\sum }_{b ∈ B} {P}_{b}}{\vert M \vert} ,$$

where |M| is the total number of machines and max(P_{b},b∈B) represents the maximum batch processing time in all batches;

step 3″: assuming

$${C}_{max} = \frac{LB + UB}{2} ;$$

step 4″: selecting one batch for assignment to a machine every time and ensuring the sum of processing time for this machine not exceeding Cₘₐₓ;
if the batch cannot be put on the machine under the limitation of not exceeding Cₘₐₓ, resetting LB=Cₘₐₓ; or otherwise, resetting UB=Cₘₐₓ;

step 5″: determining whether

$$\frac{UB - LB}{LB} \leq NE$$

is satisfied; if so, ending the circulation; if not, returning to the step 3″.

Optionally, the step of selecting particles by a “tournament” method, sequencing the particles in non-decreasing order of the fitness values, and selecting first 20% particles to perform a randomly pairwise crossover operation by the calculation module includes:

step 41: randomly selecting two individuals, comparing fitness values for the two individuals, and selecting the individual having a larger fitness value as a candidate crossover particle; selecting 20% particles from a population to perform a randomly pairwise crossover operation on the selected particles on the premise of ensuring the number of particles to be an even number, rounding off the number of particles if it is a decimal and adding 1 to the number of particles if it is an odd number, to generate corresponding filial particles to replace parent particles, wherein the specific crossover method is as follows: on the basis of dimensions, randomly generating 0 or 1 for each dimension; if it is 1, exchanging the value of the dimension; or otherwise, not exchanging the value;

step 42: calculating the mutation probability of a particle m according to the following formula:

$${P}_{m} = \{ \begin{matrix}{P}_{1} - \frac{( {P}_{1} - {P}_{2} ) ( {f}_{avg} - f )}{{f}_{avg} - {f}_{min}} , & f \leq {f}_{avg} \\ {P}_{1} , & f > {f}_{avg}\end{matrix}$$

where, fₘᵢₙ represents a fitness value for the globally optimal position, f_{avg} represents an average fitness value, f represents a fitness value for the current particle, P₁=0.1 and P₂=0.01; generating a random decimal within [0,1] for each particle and comparing the random decimal with Pₘ; if it is less than Pₘ, performing mutation on the particle, or otherwise, not performing mutation, where the specific mutation method is as follows: on the basis of dimensions, randomly generating 0 or 1 for each dimension; if it is 1, performing mutation on the value of the dimension to change 1 to 0 or change 0 to 1, or otherwise, not performing mutation.

In the embodiments of the present invention, in view of the collaborative scheduling problem of production and transportation considering distributed storage, jobs are batched and corrected by encoding by improved particle swarm optimization, and a corresponding batch assignment strategy is proposed according to the nature of the problem to calculate a fitness value for a corresponding individual; and, a crossover mutation operation is performed on particles based on the fitness of the solution, and search is performed in the whole solution space and the population is updated by repetitive iteration to eventually obtain an approximately optimal solution. The improved particle swarm optimization is a high-efficiency algorithm in terms of convergence rate and convergence effect. By this algorithm, the collaborative scheduling of production and transportation considering distributed storage is realized, the production efficiency of supply chains is improved, the cost is reduced for supply chains, and the service level of supply chains is enhanced.

### BRIEF DESCRIPTION OF THE DRAWINGS

Various other advantages and benefits will become apparent to a person of ordinary skill in the art by reading the following detailed description of the preferred embodiments. The drawings are only for the purpose of illustrating the preferred embodiments, but not for the purpose of limiting the present invention. Also, identical components are denoted by identical reference numbers throughout the drawings, in which:

FIG. 1 is a schematic structure diagram of collaborative scheduling of production on parallel machines and transportation in two stages according to one embodiment of the present invention;

FIG. 2 is a schematic flowchart of a method for collaborative scheduling of production and transportation in supply chains based on improved particle swarm optimization according to one embodiment of the present invention; and

FIG. 3 is a schematic structure diagram of a system for collaborative scheduling of production and transportation in supply chains based on improved particle swarm optimization according to one embodiment of the present invention.

### DETAILED DESCRIPTION OF THE PRESENT INVENTION

The technical solutions in the embodiments of the present invention will be clearly and completely described as below with reference to the accompanying drawings in the embodiments of the present invention. Obviously, the described embodiments are only a part of, not all of, the embodiments of the present invention. All other embodiments obtained by a person of ordinary skill in the art based on the embodiments of the present invention without paying any creative effort shall fall into the protection scope of the present invention.

An objective of the present invention is to solve the collaborative scheduling problem of production on parallel machines and transportation considering distributed storage, which includes two aspects: (1) batching jobs; and, (2) assigning different batches to corresponding batch processors for processing. The batching problem refers to dividing jobs transported from a warehouse to a manufacturer into multiple batches if the capacity of a batch processor is enough; and the batch assignment problem refers to determining a machine to which batches are to be assigned and the processing sequence of batches arranged on a same machine. In the present invention, based on the nature of the problem, the convergence problem of the traditional particle swarm optimization is overcome, an improved particle swarm optimization is proposed, and the efficiency of intelligently making decisions is improved.

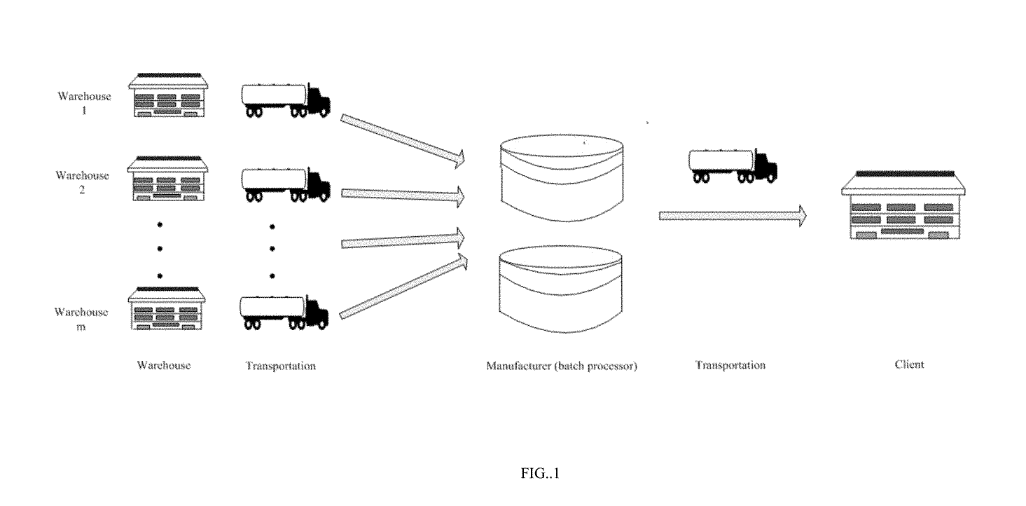

For ease of understanding, the problem to be solved by the method according to the embodiments of the present invention will be described below with reference to FIG. 1.

The collaborative scheduling problem of production on parallel machines and transportation considering distributed storage is to minimize the makespan. This problem is described as follows: a set of tasks J={J₁, J₂, J₃, . . . , Jₙ} containing n jobs and m warehouses distributed in different geographical locations are provided. Different jobs are different in processing time and size, which are denoted by pᵢ and sᵢ (i=1, 2, . . . , n), respectively. There are three stages in view of this problem, i.e. a stage of transporting jobs from warehouses to a manufacturer, a stage of processing jobs on machines of the manufacturer, and a stage of transporting from the manufacturer to clients. The description will be given under the following assumption:

(1) In the stage of transporting semi-finished jobs from warehouses to the manufacturer, each warehouse has only one vehicle, and only one job can be carried every time; it is assumed that the round-trip transportation time for the vehicle in each warehouse to the manufacturer is fixed, which is denoted by T={T₁, T₂, T₃, . . . , Tₙ}.

(2) In the stage of processing jobs, batch processors belong to same-type parallel machines; the capacity of each batch processor is set as B, that is, the sum of the size of all jobs in any batch bₖ (k=1, 2, . . . , l) is not greater than B, and it is assumed that the size of all jobs is not greater than the capacity of the machine. During processing, jobs in a same batch are simultaneously processed, the processing time for a batch bₖ is P_{b}, and P_{b} is equal to the maximum processing time in batches.

(3) In the stage of transporting jobs from the manufacturer to the clients, there is only one vehicle for the manufacturer to transport the processed jobs to the clients. The capacity of the vehicle is equal to the capacity of batch processors, i.e. B. It is assumed that the round-trip transportation time for the vehicle between the manufacturer and the clients is t, the single-trip transportation time is t/2. For ease of description, the time for loading and unloading jobs is contained in the transportation time.

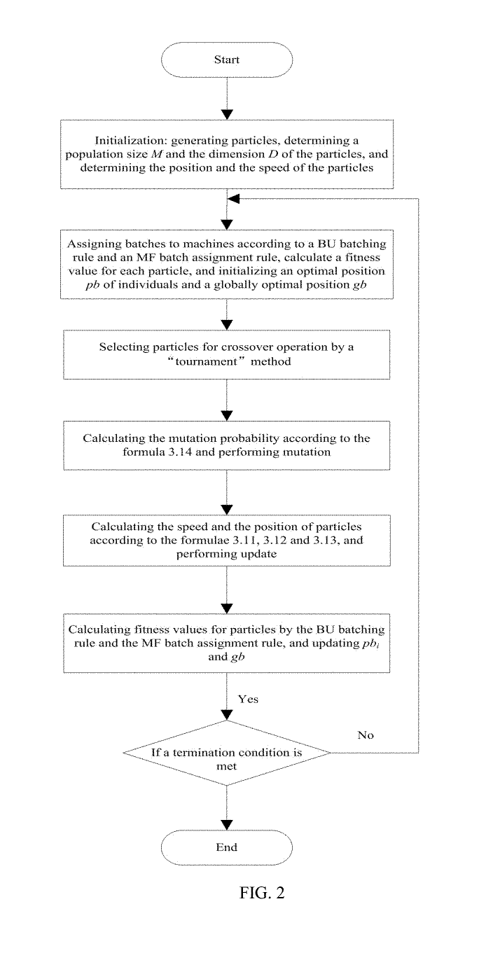

On this basis, an embodiment of the present invention provides a method for collaborative scheduling of production and transportation in supply chains based on improved particle swarm optimization, with reference to FIG. 2, including:

step 1: assuming, from the model analysis, that the vehicle in each warehouse is kept busy transporting jobs from the moment in time 0 until the total number of jobs at the manufacturer reaches the number of orders for clients, then: obtaining the number of jobs transported by each warehouse; obtaining a sequence of jobs on a first-come-first-served basis; representing a code of the m^{th} particle by a vector Xₘ={x₁ₘ, x₂ₘ, . . . , xᵢₘ, . . . , xₙₘ}, elements of which are valued as 0 or 1; and when an element is valued as 1, putting elements valued as 0 in front of the element into a batch, where all vectors in the n^{th} dimension are valued as 1;

step 2: initializing a particle swarm, determining a population size M of the particle swarm, the dimension D of particles, the number of iterations t=0, the maximum number of iterations tₘₐₓ, and the position xᵢₘ and the speed vᵢₘ of particles, and assigning 0 or 1 to each dimension of each particle according to an encoding rule; and selecting a random number rand between 0 and 1 and calculating the position and the speed of particles in the following way:

vᵢₘ^{t+1}=w*vᵢₘ^{t}+c₁*r₁*(pbᵢ^{t}−xᵢₘ^{t})+c₂*r₂*(gbᵢ^{t}−xᵢₘ^{t})

where, w, c₁, c₂ are constant coefficients;

$$Sig ( {v}_{im} ) = \frac{1}{1 + exp ( - {v}_{im} )}$$

$${x}_{im} = \{ \begin{matrix}1 , & Sig ( {v}_{im} ) \geq rand \\ 0 , & Sig ( {v}_{im} ) < rand\end{matrix} ;$$

step 3: correcting an initial solution according to a BU rule, assigning batches to corresponding machines for processing according to an MF batch assignment rule, calculating a fitness value for each particle by a fitness function, and updating an optimal position pb of individuals and a globally optimal position gb;

step 4: selecting particles by a “tournament” method, sequencing the particles in non-decreasing order of the fitness values, and selecting first 20% particles to perform a randomly pairwise crossover operation on the premise of ensuring the number of particles to be an even number, rounding off the number of particles if it is a decimal and adding 1 to the number of particles if it is an odd number, to generate corresponding filial particles to replace parent particles;

step 5: correcting the initial solution according to the BU rule, assigning batches to corresponding machines for processing according to the MF batch assignment rule, calculating a fitness value for each particle by the fitness function, and updating the optimal position pb of individuals and the globally optimal position gb;

step 6: calculating the mutation probability of particles to perform mutation, calculating fitness values for particles according to the BU rule and the MF batch assignment rule, and updating the optimal position pb of individuals and the globally optimal position gb;

step 7: calculating the speed and the position of all particles, updating the position xᵢₘ of particles, calculating a fitness value for each particle, and updating the optimal position pb of individuals and the globally optimal position gb, where t=t+1;

step 8: determining whether t≤tₘₐₓ is satisfied; if so, returning to the step 3; if not, ending the algorithm, and outputting the globally optimal solution gb as well as the optimal batching mode and batch processing sequences on each machine.

Wherein, in a specific implementation, the correcting an initial solution according to a BU rule may be implemented in various ways. An optional implementation includes the following steps:

step 1′: setting i=1 and j=1 for a given individual Xₘ;

step 2′: assigning a job i to the j^{th} batch if xᵢₘ=0, where i=i+1; or otherwise, assuming j=j+1, and assigning the job i to the j^{th} batch;

step 3′: determining whether i>1 is satisfied; if so, returning to the step 2′; if not, obtaining all sets of batches;

step 4′: for any batch Bⱼ, if the capacity of Bⱼ is greater than B, then: selecting a job J* arriving at a machine at the latest during transportation from a warehouse to a manufacturer and placing the job J* in a batch Bⱼ₊₁ if |Bⱼ|−B+|Bⱼ₊₁|≤B, where |Bⱼ| represents the number of jobs contained in the batch Bⱼ; or otherwise, inserting a new batch in the position j+1, placing the job J* in the batch Bⱼ₊₁, and removing the job J* from the batch Bⱼ;

step 5′: repeating the step 4′ until all batches satisfy the requirement on the capacity.

In a specific implementation, the assigning batches to corresponding machines for processing according to an MF batch assignment rule may be implemented in various ways. An optional implementation includes the following steps:

step 1″: obtaining the processing time P_{b} for each batch bₖ and setting a parameter NE after batching jobs according to batch correction;

step 2″: determining upper and lower bounds for batch assignment according to the following laws:

for the lower bound:

if

$$max ( {P}_{b} , b ∈ B ) \geq \frac{{\sum }_{b ∈ B} {P}_{b}}{\vert M \vert}$$

is satisfied, assuming LB=max(P_{b},b∈B); or otherwise, assuming

$$LB = \frac{{\sum }_{b ∈ B} {P}_{b}}{\vert M \vert} ;$$

for the upper bound:

if

$$max ( {P}_{b} , b ∈ B ) \geq \frac{2 {\sum }_{b ∈ B} {P}_{b}}{\vert M \vert}$$

is satisfied, assuming UB=max(P_{b},b∈B); or otherwise, assuming

$$UB = \frac{2 {\sum }_{b ∈ B} {P}_{b}}{\vert M \vert} ,$$

where |M| is the total number of machines and max(P_{b},b∈B) represents the maximum batch processing time in all batches;

step 3″: assuming

$${C}_{max} = \frac{LB + UB}{2} ;$$

step 4″: selecting one batch for assignment to a machine every time and ensuring the sum of processing time for this machine not exceeding Cₘₐₓ;

if the batch cannot be put on the machine under the limitation of not exceeding Cₘₐₓ, resetting LB=Cₘₐₓ; or otherwise, resetting UB=Cₘₐₓ;

step 5″: determining whether

$$\frac{UB - LB}{LB} \leq NE$$

is satisfied; if so, ending the circulation; if not, returning to the step 3″.

In a specific implementation, the selecting particles by a “tournament” method, sequencing the particles in non-decreasing order of the fitness values, and selecting first 20% particles to perform a randomly pairwise crossover operation may be implemented in various ways. An optional implementation includes the following steps:

step 41: randomly selecting two individuals, comparing fitness values for the two individuals, and selecting the individual having a larger fitness value as a candidate crossover particle; selecting 20% particles from a population to perform a randomly pairwise crossover operation on the selected particles on the premise of ensuring the number of particles to be an even number, rounding off the number of particles if it is a decimal and adding 1 to the number of particles if it is an odd number, to generate corresponding filial particles to replace parent particles, wherein the specific crossover method is as follows: on the basis of dimensions, randomly generating 0 or 1 for each dimension; if it is 1, exchanging the value of the dimension; or otherwise, not exchanging the value;

step 42: calculating the mutation probability of a particle m according to the following formula:

$${P}_{m} = \{ \begin{matrix}{P}_{1} - \frac{( {P}_{1} - {P}_{2} ) ( {f}_{avg} - f )}{{f}_{avg} - {f}_{min}} , & f \leq {f}_{avg} \\ {P}_{1} , & f > {f}_{avg}\end{matrix}$$

where, fₘᵢₙ represents a fitness value for the globally optimal position, f_{avg} represents an average fitness value, f represents a fitness value for the current particle, P₁=0.1 and P₂=0.01; generating a random decimal within [0,1] for each particle and comparing the random decimal with Pₘ; if it is less than Pₘ, performing mutation on the particle, or otherwise, not performing mutation, where the specific mutation method is as follows: on the basis of dimensions, randomly generating 0 or 1 for each dimension; if it is 1, performing mutation on the value of the dimension to change 1 to 0 or change 0 to 1, or otherwise, not performing mutation.

The method according to the embodiment of the present invention has the following beneficial effects.

1. In the embodiments of the present invention, in view of the collaborative scheduling problem of production and transportation considering distributed storage, jobs are batched and corrected by encoding by improved particle swarm optimization, and a corresponding batch assignment strategy is proposed according to the nature of the problem to calculate a fitness value of a corresponding individual; and, a crossover mutation operation is performed on particles based on the fitness of the solution, and search is performed in the whole solution space and the population is updated by repetitive iteration to eventually obtain an approximately optimal solution. The improved particle swarm optimization is a high-efficiency algorithm in terms of convergence rate and convergence effect. By this algorithm, the collaborative scheduling of production and transportation considering distributed storage is realized, the production efficiency of supply chains is improved, the cost is reduced for supply chains, and the service level of supply chains is enhanced.

2. In the embodiments of the present invention, a 2D encoding method is used on codes of solutions according to the nature of the problem; by providing an encoding correction strategy applied in the whole algorithm solving based on the encoding method, and by ensuring the adjustment of individuals after the generation of any individual, the generation of infeasible solutions is avoided; and, by using a heuristic algorithm to perform assignment and processing of batches, the search efficiency and the convergence rate of the algorithm are improved, and it is advantageous for the utmost search of an optimal solution from the solution space by the algorithm.

3. In the embodiments of the present invention, crossover and mutation strategies based on 2D encoding are introduced in view of problems of poor global convergence and premature convergence in the particle swarm optimization, so that advantages in convergence rate of the original particle swarm optimization are retained, the diversity of populations is increased, and the performance of algorithms is improved by fusing population updating strategies of two algorithms.

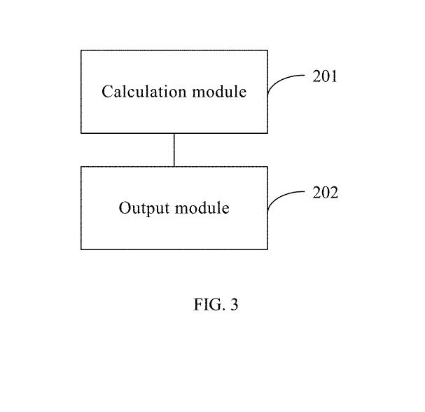

Based on the same concept, another embodiment of the present invention further provides a system for collaborative scheduling of production and transportation in supply chains based on improved particle swarm optimization, with reference to FIG. 3, including:

a calculation module 201 used for:

step 1: obtaining the number of jobs transported by each warehouse; obtaining a sequence of jobs on a first-come-first-served basis; by encoding by digits 0 and 1, representing a code of the m^{th} particle by a vector Xₘ={x₁ₘ, x₂ₘ, . . . , xᵢₘ, . . . , xₙₘ}, elements of which are valued as 0 or 1; and when an element is valued as 1, putting elements valued as 0 in front of the element into a batch, where all vectors in the n^{th} dimension are valued as 1;

step 2: initializing a particle swarm, determining a population size M of the particle swarm, the dimension D of particles, the number of iterations t=0, the maximum number of iterations tₘₐₓ, and the position xᵢₘ and the speed vᵢₘ of particles, and assigning 0 or 1 to each dimension of each particle according to an encoding rule; and selecting a random number rand between 0 and 1 and calculating the position and the speed of particles in the following way:

vᵢₘ^{t+1}=w*vᵢₘ^{t}+c₁*r₁*(pbᵢ^{t}−xᵢₘ^{t})+c₂*r₂*(gbᵢ^{t}−xᵢₘ^{t})

where, w, c₁, c₂ are constant coefficients;

$$Sig ( {v}_{im} ) = \frac{1}{1 + exp ( - {v}_{im} )}$$

$${x}_{im} = \{ \begin{matrix}1 , & Sig ( {v}_{im} ) \geq rand \\ 0 , & Sig ( {v}_{im} ) < rand\end{matrix} ;$$

step 3: correcting an initial solution according to a BU rule, assigning batches to corresponding machines for processing according to an MF batch assignment rule, calculating a fitness value for each particle by a fitness function, and updating an optimal position pb of individuals and a globally optimal position gb;

step 4: selecting particles by a “tournament” method, sequencing the particles in non-decreasing order of the fitness values, and selecting first 20% particles to perform a randomly pairwise crossover operation on the premise of ensuring the number of particles to be an even number, rounding off the number of particles if it is a decimal and adding 1 to the number of particles if it is an odd number, to generate corresponding filial particles to replace parent particles;

step 5: correcting the initial solution according to the BU rule, assigning batches to corresponding machines for processing according to the MF batch assignment rule, calculating a fitness value for each particle by the fitness function, and updating the optimal position pb of individuals and the globally optimal position gb;

step 6: calculating the mutation probability of particles to perform mutation, calculating fitness values for particles according to the BU rule and the MF batch assignment rule, and updating the optimal position pb of individuals and the globally optimal position gb;

step 7: calculating the speed and the position of all particles, updating the position xᵢₘ of particles, calculating a fitness value for each particle, and updating the optimal position pb of individuals and the globally optimal position gb, where t=t+1;

step 8: determining whether t≤tₘₐₓ is satisfied; if so, returning to the step 3; if not, ending the algorithm, and outputting the globally optimal solution gb;

an output module 202 used for outputting the optimal batching mode and batch processing sequences on each machine.

In a specific implementation, the step of correcting an initial solution according to a BU rule by the calculation module 201 includes:

step 1′: setting i=1 and j=1 for a given individual Xₘ;

step 2′: assigning a job i to the j^{th} batch if xᵢₘ=0, where i=i+1; or otherwise, assuming j=j+1, and assigning the job i to the j^{th} batch;

step 3′: determining whether i>1 is satisfied; if so, returning to the step 2′; if not, obtaining all sets of batches;

step 4′: for any batch Bⱼ, if the capacity of Bⱼ is greater than B, then: selecting a job J* arriving at a machine at the latest during transportation from a warehouse to a manufacturer and placing the job J* in a batch Bⱼ₊₁ if |Bⱼ|−B+|Bⱼ₊₁|≤B, where |Bⱼ| represents the number of jobs contained in the batch Bⱼ; or otherwise, inserting a new batch in the position j+1, placing the job J* in the batch Bⱼ₊₁, and removing the job J* from the batch Bⱼ;

step 5′: repeating the step 4′ until all batches satisfy the requirement on the capacity.

In a specific implementation, the step of assigning batches to corresponding machines for processing according to an MF batch assignment rule by the calculation module 201 includes:

step 1″: obtaining the processing time P_{b} for each batch bₖ and setting a parameter NE after batching jobs according to batch correction;

step 2″: determining upper and lower bounds for batch assignment according to the following laws:

for the lower bound:

if

$$max ( {P}_{b} , b ∈ B ) \geq \frac{{\sum }_{b ∈ B} {P}_{b}}{\vert M \vert}$$

is satisfied, assuming LB=max(P_{b},b∈B); or

otherwise, assuming

$$LB = \frac{{\sum }_{b ∈ B} {P}_{b}}{\vert M \vert} ;$$

for the upper bound:

if

$$max ( {P}_{b} , b ∈ B ) \geq \frac{2 {\sum }_{b ∈ B} {P}_{b}}{\vert M \vert}$$

is satisfied, assuming UB=max(P_{b},b∈B); or otherwise, assuming

$$UB = \frac{2 {\sum }_{b ∈ B} {P}_{b}}{\vert M \vert} ,$$

where |M| is the total number of machines and max(P_{b},b∈B) represents the maximum batch processing time in all batches;

step 3″: assuming

$${C}_{max} = \frac{LB + UB}{2} ;$$

step 4″: selecting one batch for assignment to a machine every time and ensuring the sum of processing time for this machine not exceeding Cₘₐₓ;

if the batch cannot be put on the machine under the limitation of not exceeding Cₘₐₓ, resetting LB=Cₘₐₓ; or otherwise, resetting UB=Cₘₐₓ;

step 5″: determining whether

$$\frac{UB - LB}{LB} \leq NE$$

is satisfied; if so, ending the circulation; if not, returning to the step 3″.

In a specific implementation, the step of selecting particles by a “tournament” method, sequencing the particles in non-decreasing order of the fitness values, and selecting first 20% particles to perform a randomly pairwise crossover operation by the calculation module 201 includes:

step 41: randomly selecting two individuals, comparing fitness values for the two individuals, and selecting the individual having a larger fitness value as a candidate crossover particle; selecting 20% particles from a population to perform a randomly pairwise crossover operation on the selected particles on the premise of ensuring the number of particles to be an even number, rounding off the number of particles if it is a decimal and adding 1 to the number of particles if it is an odd number, to generate corresponding filial particles to replace parent particles, wherein the specific crossover method is as follows: on the basis of dimensions, randomly generating 0 or 1 for each dimension; if it is 1, exchanging the value of the dimension; or otherwise, not exchanging the value;

step 42: calculating the mutation probability of a particle m according to the following formula:

$${P}_{m} = \{ \begin{matrix}{P}_{1} - \frac{( {P}_{1} - {P}_{2} ) ( {f}_{avg} - f )}{{f}_{avg} - {f}_{min}} , & f \leq {f}_{avg} \\ {P}_{1} , & f > {f}_{avg}\end{matrix}$$

where, fₘᵢₙ represents a fitness value for the globally optimal position, f_{avg} represents an average fitness value, f represents a fitness value for the current particle, P₁=0.1 and P₂=0.01; generating a random decimal within [0,1] for each particle and comparing the random decimal with Pₘ; if it is less than Pₘ, performing mutation on the particle, or otherwise, not performing mutation, where the specific mutation method is as follows: on the basis of dimensions, randomly generating 0 or 1 for each dimension; if it is 1, performing mutation on the value of the dimension to change 1 to 0 or change 0 to 1, or otherwise, not performing mutation.

An embodiment of the present invention further discloses a computer program product which includes computer programs. The computer programs include program instructions that, when executed by a computer, enable the computer to execute the method according to the above method embodiments, for example, the method described in the first aspect.

A lot of specific details have been described in the specification provided herein. However, it can be appreciated that the embodiments of the present invention may be practiced without these specific details. In some examples, well-known methods, structures and techniques have not been shown in detail so as not to obscure the understanding to this specification.

Similarly, it should be appreciated that in the above description of exemplary embodiments of the present invention, various features of the present invention are sometimes combined together in a single embodiment, figure, or description thereof for the purpose of streamlining the disclosure and aiding in the understanding of one or more of the various inventive aspects. However, the method of the disclosure is not to be interpreted as reflecting an intention that the claimed embodiments of the invention require more features than those expressly recited in each claim. Rather, as reflected by the following claims, inventive aspects are less than all features of a single foregoing embodiment. Thus, the claims following the specific implementation mode are hereby expressly incorporated herein just as each claim itself is a separate embodiment of the present invention.

What is claimed is:

1. A method for collaborative scheduling of production and transportation in supply chains based on improved particle swarm optimization, comprising:
step 1: obtaining the number of jobs transported by each warehouse; obtaining a sequence of jobs on a first-come-first-served basis; representing a code of the m^{th} particle by a vector Xₘ={x₁ₘ, x₂ₘ, . . . , xᵢₘ, . . . , xₙₘ}, elements of which are valued as 0 or 1; and when an element is valued as 1, putting elements valued as 0 in front of the element into a batch, where all vectors in the n^{th} dimension are valued as 1;
step 2: initializing a particle swarm, determining a population size M of the particle swarm, the dimension D of particles, the number of iterations t=0, the maximum number of iterations tₘₐₓ, and the position xᵢₘ and the speed vᵢₘ of particles, and assigning 0 or 1 to each dimension of each particle according to an encoding rule; and selecting a random number rand between 0 and 1 and calculating the position and the speed of particles in the following way:
vᵢₘ^{t+1}=w*vᵢₘ^{t}+c₁*r₁*(pbᵢ^{t}−xᵢₘ^{t})+c₂*r₂*(gbᵢ^{t}−xᵢₘ^{t})
where, w, c₁, c₂ are constant coefficients;
$$Sig ( {v}_{im} ) = \frac{1}{1 + exp ( - {v}_{im} )}$$
$${x}_{im} = \{ \begin{matrix}1 , & Sig ( {v}_{im} ) \geq rand \\ 0 , & Sig ( {v}_{im} ) < rand\end{matrix} ;$$
step 3: correcting an initial solution according to a BU rule, assigning batches to corresponding machines for processing according to an MF batch assignment rule, calculating a fitness value for each particle by a fitness function, and updating an optimal position pb of individuals and a globally optimal position gb;
step 4: selecting particles by a “tournament” method, sequencing the particles in non-decreasing order of the fitness values, and selecting first 20% particles to perform a randomly pairwise crossover operation on the premise of ensuring the number of particles to be an even number, rounding off the number of particles if it is a decimal and adding 1 to the number of particles if it is an odd number, to generate corresponding filial particles to replace parent particles;
step 5: correcting the initial solution according to the BU rule, assigning batches to corresponding machines for processing according to the MF batch assignment rule, calculating a fitness value for each particle by the fitness function, and updating the optimal position pb of individuals and the globally optimal position gb;
step 6: calculating the mutation probability of particles to perform mutation, calculating fitness values for particles according to the BU rule and the MF batch assignment rule, and updating the optimal position pb of individuals and the globally optimal position gb;
step 7: calculating the speed and the position of all particles, updating the position xᵢₘ of particles, calculating a fitness value for each particle, and updating the optimal position pb of individuals and the globally optimal position gb, where t=t+1;
step 8: determining whether t≤tₘₐₓ is satisfied; if so, returning to the step 3; if not, ending the algorithm, and outputting the globally optimal solution gb as well as the optimal batching mode and batch processing sequences on each machine;
the step of correcting an initial solution according to a BU rule comprises:
step 1′: setting i=1 and j=1 for a given individual Xₘ;
step 2′: assigning a job i to the j^{th} batch if xᵢₘ=0, where i=i+1; or otherwise, assuming j=j+1, and assigning the job i to the j^{th} batch;
step 3′: determining whether i>1 is satisfied; if so, returning to the step 2′; if not, obtaining all sets of batches;
step 4′: for any batch Bⱼ, if the capacity of Bⱼ is greater than B, then: selecting a job J* arriving at a machine at the latest during transportation from a warehouse to a manufacturer and placing the job J* in a batch Bⱼ₊₁ if |Bⱼ|−B+|Bⱼ₊₁|≤B, where |Bⱼ| represents the number of jobs contained in the batch Bⱼ; or otherwise, inserting a new batch in the position j+1, placing the job J* in the batch Bⱼ₊₁, and removing the job J* from the batch Bⱼ; where B represents an upper limit for the capacity of each batch;
step 5′: repeating the step 4′ until all batches satisfy the requirement on the capacity.

2. The method according to claim 1, wherein, the step of assigning batches to corresponding machines for processing according to an MF batch assignment rule comprises:
step 1″: obtaining the processing time P_{b} for each batch bₖ and setting a parameter NE after batching jobs according to the BU rule;
step 2″: determining upper and lower bounds for batch assignment according to the following laws:
for the lower bound:
if
$$max ( {P}_{b} , b ∈ B ) \geq \frac{{\sum }_{b ∈ B} {P}_{b}}{\vert M \vert}$$
is satisfied, assuming LB=max(P_{b},b∈B); or otherwise, assuming
$$LB = \frac{{\sum }_{b ∈ B} {P}_{b}}{\vert M \vert} ;$$
for the upper bound:
if
$$max ( {P}_{b} , b ∈ B ) \geq \frac{2 {\sum }_{b ∈ B} {P}_{b}}{\vert M \vert}$$
is satisfied, assuming UB=max(P_{b},b∈B); or otherwise, assuming
$$UB = \frac{2 {\sum }_{b ∈ B} {P}_{b}}{\vert M \vert} ,$$
where |M| is the total number of machines and max(P_{b},b∈B) represents the maximum batch processing time in all batches;
step 3″: assuming
$${C}_{max} = \frac{LB + UB}{2} ;$$
step 4″: selecting one batch for assignment to a machine every time and ensuring the sum of processing time for this machine not exceeding Cₘₐₓ;
if the batch cannot be put on the machine under the limitation of not exceeding Cₘₐₓ, resetting LB=Cₘₐₓ; or otherwise, resetting UB=Cₘₐₓ;
step 5″: determining whether
$$\frac{UB - LB}{LB} \leq NE$$
is satisfied; if so, ending the circulation; if not, returning to the step 3″.

3. The method according to claim 1, wherein, the step of selecting particles by a “tournament” method, sequencing the particles in non-decreasing order of the fitness values, and selecting first 20% particles to perform a randomly pairwise crossover operation comprises:
step 41: randomly selecting two individuals, comparing fitness values for the two individuals, and selecting the individual having a larger fitness value as a candidate crossover particle; selecting 20% particles from a population to perform a randomly pairwise crossover operation on the selected particles on the premise of ensuring the number of particles to be an even number, rounding off the number of particles if it is a decimal and adding 1 to the number of particles if it is an odd number, to generate corresponding filial particles to replace parent particles, wherein the specific crossover method is as follows: on the basis of dimensions, randomly generating 0 or 1 for each dimension; if it is 1, exchanging the value of the dimension; or otherwise, not exchanging the value;
step 42: calculating the mutation probability of a particle m according to the following formula:
$${P}_{m} = \{ \begin{matrix}{P}_{1} - \frac{( {P}_{1} - {P}_{2} ) ( {f}_{avg} - f )}{{f}_{avg} - {f}_{min}} , f \leq {f}_{avg} \\ {P}_{1} , f > {f}_{avg}\end{matrix}$$
where, fₘᵢₙ represents a fitness value for the globally optimal position, f_{avg} represents an average fitness value, f represents a fitness value for the current particle, P₁=0.1 and P₂=0.01; generating a random decimal within [0,1] for each particle and comparing the random decimal with Pₘ; if it is less than Pₘ, performing mutation on the particle, or otherwise, not performing mutation, where the specific mutation method is as follows: on the basis of dimensions, randomly generating 0 or 1 for each dimension; if it is 1, performing mutation on the value of the dimension to change 1 to 0 or change 0 to 1, or otherwise, not performing mutation.

4. A system for collaborative scheduling of production and transportation in supply chains based on improved particle swarm optimization, comprising:
a calculation module used for:
step 1: obtaining the number of jobs transported by each warehouse; obtaining a sequence of jobs on a first-come-first-served basis; representing a code of the m^{th} particle by a vector Xₘ={x₁ₘ, x₂ₘ, . . . , xᵢₘ, . . . , xₙₘ}, elements of which are valued as 0 or 1; and when an element is valued as 1, putting elements valued as 0 in front of the element into a batch, where all vectors in the n^{th} dimension are valued as 1;
step 2: initializing a particle swarm, determining a population size M of the particle swarm, the dimension D of particles, the number of iterations t=0, the maximum number of iterations tₘₐₓ, and the position xᵢₘ and the speed vᵢₘ of particles, and assigning 0 or 1 to each dimension of each particle according to an encoding rule; and selecting a random number rand between 0 and 1 and calculating the position and the speed of particles in the following way:
vᵢₘ^{t+1}=w*vᵢₘ^{t}+c₁*r₁*(pbᵢ^{t}−xᵢₘ^{t})+c₂*r₂*(gbᵢ^{t}−xᵢₘ^{t})
where, w, c₁, c₂ are constant coefficients;
$$Sig ( {v}_{im} ) = \frac{1}{1 + exp ( - {v}_{im} )}$$
$${x}_{im} = \{ \begin{matrix}1 , & Sig ( {v}_{im} ) \geq rand \\ 0 , & Sig ( {v}_{im} ) < rand\end{matrix} ;$$
step 3: correcting an initial solution according to a BU rule, assigning batches to corresponding machines for processing according to an MF batch assignment rule, calculating a fitness value for each particle by a fitness function, and updating an optimal position pb of individuals and a globally optimal position gb;
step 4: selecting particles by a “tournament” method, sequencing the particles in non-decreasing order of the fitness values, and selecting first 20% particles to perform a randomly pairwise crossover operation on the premise of ensuring the number of particles to be an even number, rounding off the number of particles if it is a decimal and adding 1 to the number of particles if it is an odd number, to generate corresponding filial particles to replace parent particles;
step 5: correcting the initial solution according to the BU rule, assigning batches to corresponding machines for processing according to the MF batch assignment rule, calculating a fitness value for each particle by the fitness function, and updating the optimal position pb of individuals and the globally optimal position gb;
step 6: calculating the mutation probability of particles to perform mutation, calculating fitness values for particles according to the BU rule and the MF batch assignment rule, and updating the optimal position pb of individuals and the globally optimal position gb;
step 7: calculating the speed and the position of all particles, updating the position xᵢₘ of particles, calculating a fitness value for each particle, and updating the optimal position pb of individuals and the globally optimal position gb, where t=t+1;
step 8: determining whether t≤tₘₐₓ is satisfied; if so, returning to the step 3; if not, ending the algorithm, and outputting the globally optimal solution gb;
an output module used for outputting the optimal batching mode and batch processing sequences on each machine;
the step of correcting an initial solution according to a BU rule by the calculation module comprises:
step 1′: setting i=1 and j=1 for a given individual Xₘ;
step 2′: assigning a job i to the j^{th} batch if xᵢₘ=0, where i=i+1; or otherwise, assuming j=j+1, and assigning the job i to the j^{th} batch;
step 3′: determining whether i>1 is satisfied; if so, returning to the step 2′; if not, obtaining all sets of batches;
step 4′: for any batch Bⱼ, if the capacity of Bⱼ is greater than B, then: selecting a job J* arriving at a machine at the latest during transportation from a warehouse to a manufacturer and placing the job J* in a batch Bⱼ₊₁ if |Bⱼ|−B+|Bⱼ₊₁|≤B, where |Bⱼ| represents the number of jobs contained in the batch Bⱼ; or otherwise, inserting a new batch in the position j+1, placing the job J* in the batch Bⱼ₊₁, and removing the job J* from the batch Bⱼ; where B represents an upper limit for the capacity of each batch;
step 5′: repeating the step 4′ until all batches satisfy the requirement on the capacity.

5. The system according to claim 4, wherein, the step of assigning batches to corresponding machines for processing according to an MF batch assignment rule by the calculation module comprises:
step 1″: obtaining the processing time bₖ for each batch P_{b} and setting a parameter NE after batching jobs according to the BU rule;
step 2″: determining upper and lower bounds for batch assignment according to the following laws:
for the lower bound:
if
$$max ( {P}_{b} , b ∈ B ) \geq \frac{{\sum }_{b ∈ B} {P}_{b}}{\vert M \vert}$$
is satisfied, assuming LB=max(P_{b},b∈B); or otherwise, assuming
$$LB = \frac{{\sum }_{b ∈ B} {P}_{b}}{\vert M \vert} ;$$
for the upper bound:
if
$$max ( {P}_{b} , b ∈ B ) \geq \frac{2 {\sum }_{b ∈ B} {P}_{b}}{\vert M \vert}$$
is satisfied, assuming UB=max(P_{b},b∈B); or otherwise, assuming
$$UB = \frac{2 {\sum }_{b ∈ B} {P}_{b}}{\vert M \vert} ,$$
where |M| is the total number of machines and max(P_{b},b∈B) represents the maximum batch processing time in all batches;
step 3″: assuming
$${C}_{max} = \frac{LB + UB}{2} ;$$
step 4″: selecting one batch for assignment to a machine every time and ensuring the sum of processing time for this machine not exceeding Cₘₐₓ;
if the batch cannot be put on the machine under the limitation of not exceeding Cₘₐₓ, resetting LB=Cₘₐₓ; or otherwise, resetting UB=Cₘₐₓ;
step 5″: determining whether
$$\frac{UB - LB}{LB} \leq NE$$
is satisfied; if so, ending the circulation; if not, returning to the step 3″.

6. The system according to claim 4, wherein, the step of selecting particles by a “tournament” method, sequencing the particles in non-decreasing order of the fitness values, and selecting first 20% particles to perform a randomly pairwise crossover operation by the calculation module comprises:
step 41: randomly selecting two individuals, comparing fitness values for the two individuals, and selecting the individual having a larger fitness value as a candidate crossover particle; selecting 20% particles from a population to perform a randomly pairwise crossover operation on the selected particles on the premise of ensuring the number of particles to be an even number, rounding off the number of particles if it is a decimal and adding 1 to the number of particles if it is an odd number, to generate corresponding filial particles to replace parent particles, wherein the specific crossover method is as follows: on the basis of dimensions, randomly generating 0 or 1 for each dimension; if it is 1, exchanging the value of the dimension; or otherwise, not exchanging the value;
step 42: calculating the mutation probability of a particle m according to the following formula:
$${P}_{m} = \{ \begin{matrix}{P}_{1} - \frac{( {P}_{1} - {P}_{2} ) ( {f}_{avg} - f )}{{f}_{avg} - {f}_{min}} , f \leq {f}_{avg} \\ {P}_{1} , f > {f}_{avg}\end{matrix}$$
where, fₘᵢₙ represents a fitness value for the globally optimal position, f_{avg} represents an average fitness value, f represents a fitness value for the current particle, P₁=0.1 and P₂=0.01; generating a random decimal within [0,1] for each particle and comparing the random decimal with Pₘ; if it is less than Pₘ, performing mutation on the particle, or otherwise, not performing mutation, where the specific mutation method is as follows: on the basis of dimensions, randomly generating 0 or 1 for each dimension; if it is 1, performing mutation on the value of the dimension to change 1 to 0 or change 0 to 1, or otherwise, not performing mutation.
